(19) United States
(12) Patent Application Publication
(10) Pub. No.: US 2024/0286950 A1
(43) Pub. Date: Aug. 29, 2024

(54) ELECTRONICALLY CONDUCTIVE ENAMEL COATING

(71) Applicant: Technische Universität Bergakademie Freiberg, Freiberg (DE)

(72) Inventors: Torsten Lorenz, Freiberg (DE); Sabine Hönig, Freiberg (DE)

(73) Assignee: Technische Universität Bergakademie Freiberg, Freiberg (DE)

(21) Appl. No.: 18/572,484

(22) PCT Filed: Jun. 21, 2022
(86) PCT No.: PCT/EP2022/066789

§ 371 Date: Dec. 20, 2023

(30) Foreign Application Priority Data
Jun. 21, 2021 (DE) 102021116028.6

(51) Int. Cl. C03C 8/18; C23D 5/04

(52) U.S. Cl. CPC C03C 8/18; C23D 5/04; C03C 2207/04

(57) ABSTRACT

The present invention relates to a composition for producing an enamel functional layer, especially an antistatic layer or an electronically conductive corrosion protection layer, to the use of this composition, to a process for producing an enamel coating on a substrate, and to articles having a base body and an enamel functional layer.

### BACKGROUND OF THE INVENTION

The present invention relates to a composition for producing an enamel functional layer, especially an antistatic layer or an electronically conductive corrosion protection layer, to the use of this composition, to a process for producing an enamel coating on a substrate, and to articles comprising a base body and an enamel functional layer.

Enameled coatings are used in particular to protect surfaces against atmospheric and chemical influences (e.g. strong acids, alkalis, etc.), particularly at higher temperatures. Enameled coatings are suitable for protecting surfaces made of metallic materials such as cast iron, steel or aluminum. Typical areas of application are linings and coatings for boilers, plant and reactors, pipelines and fittings, baths and containers, tanks, and silos, especially for storing, treating and transporting corrosive and abrasive media.

Enamel is typically a vitreous solidified mass having an inorganic, essentially oxidic composition, which is formed by melting suitable raw materials (see below) and fritting (quenching the melt) and which has been fused in one or more layers onto a base body made for example from metal.

The production of enamel comprises two separate thermal process stages, namely the production of a glass melt and the fusing (firing) on the base body to be coated of a mass (frit) formed by quenching the glass melt (fritting). This second stage of the process is also referred to as enameling. The two-stage thermal process lowers the temperature required for remelting by several hundred degrees, thereby reducing the thermal stress on the base body to be coated.

In the first step of the process, a mixture comprising raw materials for glass production such as quartz, feldspar, soda, potash, borax, cryolite and/or fluorspar and optional additives (bonding oxides, opacifiers, coloring oxides) is melted at approx. 1200° C. and then fritted (discharged into/quenched in water, for example between cooled rollers). The frit thus obtained is finely ground, optionally mixed with additives such as pigments, suspending agents, and dispersants, and applied in the form of an aqueous suspension (slip) or as a fine powder to the pretreated (cleaned and optionally roughened) surface of the base body and then fused again there. The remelting temperature (firing temperature) of enamel is in the range from 500° C. to 980° C. and depends on the base body material, on the composition of the material to be fired, and on the firing time.

Enamel comprises silicon dioxide and/or boron trioxide as glass-forming oxides (network formers). In order to keep the remelting/firing temperature of the enamel as low as possible and to increase the coefficient of thermal expansion, sodium oxide and potassium oxide are added as network modifiers, as well as suitable additives for adjusting the chemical resistance and the devitrifying behavior, for example aluminum oxide.

The frit can be applied to the base body in one or more layers. In the case of multilayer application, a distinction is made between base-coat enamel and cover enamel. The primary purpose of the base-coat enamel is mediating adhesion. In addition, it must compensate for the differences in the thermal expansion coefficient between the base body and the cover enamel. Especially for enameling cast iron or steel, the base-coat enamel comprises bonding oxides of cobalt and/or nickel, which are added to the glass melt during production of the frit. Since the base-coat enamel will often have a surface that is unevenly colored, sometimes blistered, and typically not smooth, a cover enamel is often applied afterwards. Depending on the desired visual effect, the cover enamel comprises color additives and/or opacifiers. To this end, coloring heavy metal oxides are melted into the frit for the cover enamel, or else during grinding of the frit pigments are added for example from the group consisting of cobalt, iron, manganese or chromium oxides and copper-containing spinel, rutile or zircon mixed crystals.

The glass-like material formed by fusing (firing) the frit on the surface of the base body to be coated is referred to hereinafter as an enamel matrix.

As a result of its composition described above, the enamel matrix is an electrical insulator that up to a particular electrical potential difference (depending on the layer thickness) or a particular electrical field strength does not transport charge carriers. If non-conductive fluids or solids are processed in an apparatus or container made of a metallic, i.e. electronically conductive, material having an enamel coating, an electrostatic charge can develop as a result of friction (triboelectric effect). If the critical electrical field strength is reached as a result of this electrostatic charge, an undesired puncture of the enamel layer occurs, in which the charge carriers are abruptly transported away through the damage site created. Should such unwanted puncture occur, the enamel layer will sustain irreversible damage at the sites of puncture. Not only will the electrical insulation effect of the enamel layer be lost as a result of the damage at these sites, since discharge will now continue to take place through the individual damage sites, but the corrosion protection effect of the enamel layer will be lost too, since the material to be protected will in the area of the damage site be exposed to the corrosive medium, leading to the development of pitting corrosion.

There is therefore a high need to design enamel coatings that permit dissipation of an electrostatic charge. In this respect, electrostatic precipitators (for example electric filters for exhaust gas streams in incinerators) represent an area of application with particularly high requirements. An electrostatic precipitator (electrostatic filter) comprises an active voltage source (spray electrode and precipitation electrode, the latter in the form e.g. of the enamel-coated earthed wall of the precipitator), which generates charge carriers in the medium that is in contact with the enamel layer. To avoid high field strengths, the charge carriers generated must be dissipated from the precipitation electrode. The strength of the electric field is equivalent to the number of field lines per unit area. The more field lines present, the more necessary it is for them to be evenly distributed across the precipitation electrode (enamel surface) so as to avoid the formation of secondary charge carriers. If this does not occur, due to the additional charge carriers the formation of a discharge path between the enamel-coated precipitation electrode and the spray electrode of the electrostatic precipitator (back-spraying) is promoted. This reduces the possible operating voltage and thus the performance of the electrostatic precipitator.

WO 2013/083680 A2 discloses an electronically conductive enamel composition for corrosion protection coatings in particular. The composition comprises an enamel matrix melting at a temperature in the range from 600° C. to 900° C. and—embedded in the enamel matrix—particles of one or more electronically conductive materials, the particles having a particle size of 700 μm or smaller and being selected from the group consisting of (a) particles of carbon-based electronically conductive materials, (b) particles of other electronically conductive materials that are not precious metals, (c) particles of a combination of carbon-based electronically conductive materials and other electronically conductive materials that are not precious metals. The total concentration of particles (ii) in the range from 0.09% by volume to 82.6% by volume based on the sum total of the volumes of the enamel matrix and of the particles. Preference is given to particles of stainless steel and graphite.

US 2004/0077477 A1 discloses a composition for producing a porcelain enamel having a metallic appearance. The composition comprises a glass component comprising a glass frit that melts at a temperature of less than 600° C. and metal particles, for example particles of aluminum, nickel, copper or stainless steel. The proportion of metal particles is 0.01% to 7% by weight based on the total weight of the composition. The teaching of US 2004/0077477 A1 is essentially aimed at aesthetic effects, an electronic conductivity of the coating does not play a role.

### SUMMARY OF THE INVENTION

The object of the present invention is to provide a composition for producing an enamel functional layer, especially an electronically conductive enamel layer, that is preferably suitable for use as an antistatic layer or as an electronically conductive corrosion protection layer.

The invention achieves this object by a composition comprising
(i) a frit,
(ii) particles comprising at least one metal (a),
(iii) an oxide of a metal (b) or a precursor for forming an oxide of a metal (b), where the standard electrode potential of metal (b) is more positive than the standard electrode potential of metal (a).

The composition of the invention may be in the form of a powder or a slip.

Constituent (i) of the composition of the invention comprises a frit as described above. When grinding the frit or when producing a slip comprising the frit it is possible to add additives, for example from the group consisting of opacifiers, pigments, suspending agents, and dispersants (e.g. clays). These do not count as constituents of the frit. Additives that are melted during production of the frit, such as opacifiers, coloring oxides, and bonding oxides, are on the other hand considered constituents of the frit. The present invention does not impose any restrictions on the composition of the frit and any additives; the frits and additives customarily employed for the particular application may be used, as may the raw materials customarily employed for the production thereof. The melting temperature of the frit is typically in the range from >600° C. to 980° C., preferably 620° C. to 950° C., more preferably 650° C. to 950° C.

The metals (a) and (b) in constituents (ii) and (iii) are selected such that the standard electrode potential of metal (b) is more positive than the standard electrode potential of metal (a), i.e. metal (a) is capable of reducing oxides of metal (b) to the metal (b). When firing the composition of the invention to produce an enamel functional layer (for details of the process, see below), the oxide of metal (b) is reduced by metal (a) to metal (b), forming finely branched crystalline structures of metal (b). However, the metal (a) in the particles (ii) is not completely oxidized in this process. In the enamel functional layer, particles (ii) of metal (a) remain, which are downsized by the consumption of metal (a) due to the redox reaction with the oxide of metal (b). The result is an electronically conductive network that passes through the enamel matrix, in which particles (ii) of metal (a) embedded in the enamel matrix of the enamel functional layer are connected by crystalline structures formed from the metal (b) produced by reduction of its oxide. The crystalline structures formed from metal (b) produced by reduction of its oxide that connect the particles (ii) of metal (a) are typically dendritic and/or network-like in form. The oxide of metal (a) formed in the reduction of the oxide of metal (b) is dissolved in the enamel matrix.

In the particles (ii), metal (a) may be present as the pure metal or as the principal constituent of an alloy, such as iron in steel.

Constituent (iii), i.e. the oxide of metal (b) or the precursor thereof, is present in the form of particles and/or is a constituent of the frit (i).

If constituent (iii) is a precursor for forming an oxide of a metal (b), then this precursor is preferably the metal (b) in metallic form. When the composition of the invention is fired in an oxidizing atmosphere to produce an enamel functional layer, the metal (b) is oxidized, resulting in the formation of an oxide of metal (b).

However, it is in accordance with the invention preferable that constituent (iii) of the composition of the invention is formed by an oxide of metal (b). In this case, it is preferable that the oxide of metal (b) is not a constituent of the frit (i) or not present exclusively as a constituent thereof, but is present in the form of particles of the oxide of metal (b). A “particle of an oxide of metal (b)” is understood as meaning a particle containing at least 90% by weight of this oxide of metal (b), preferably at least 95% by weight of this oxide of metal (b), more preferably at least 99% by weight of this oxide of metal (b). In the particles of a frit comprising an oxide of metal (b), the proportion of this oxide is on the other hand much lower.

The total concentration of oxide of metal (b) in the composition of the invention corresponds to at most the saturation concentration of this oxide in the melt formed when the composition of the invention is fired to produce an enamel functional layer (for details of the process, see below).

The particles (ii) are preferably steel particles, i.e. metal (a) is iron. Particular preference is given to stainless steel, especially grade 3161. The metal (b) in constituent (iii) is preferably copper.

“Stainless” steels are steels characterized by high chemical resistance in a wide range of aggressive aqueous environments. Under the influence of aggressive environmental conditions, stainless steels form a firmly-adhering, diffusion-tight oxide layer of low thickness that prevents further access of aggressive substances from the environment to the metal surface (passivity) and spontaneously regenerates in the event of damage.

Constituent (iii) is preferably formed by one or more oxides of copper, especially copper(II) oxide CuO and/or copper(I) oxide Cu₂O. Copper(II) oxide CuO and copper(I) oxide Cu₂O are hereinafter subsumed under the term “copper oxide”, which thus means both the individual oxides and mixtures of both oxides.

The copper oxide is in the form of particles and/or is a constituent of the frit (i). Frits comprising copper oxide, for example as a coloring oxide, are generally known. When the frit comprises copper oxide, the composition of the invention may comprise further copper oxide in the form of particles.

The total concentration of copper oxide in the composition of the invention corresponds to at most the saturation concentration of copper oxide in the melt formed when the composition of the invention is fired to produce an enamel functional layer (for details of the process, see below).

Alternatively, constituent (iii) may be formed by metallic copper. When the composition of the invention is fired in an oxidizing atmosphere to produce an enamel functional layer, the metallic copper is oxidized, resulting in the formation of an oxide of metal (b).

However, it is in accordance with the invention preferable that constituent (iii) of the composition of the invention is formed by copper oxide. In this case, it is preferable that the copper oxide is not a constituent of the frit or not present exclusively as a constituent thereof, but is present in the form of copper oxide particles. A “copper oxide particle” is understood as meaning a particle containing at least 90% by weight of copper oxide, preferably at least 95% by weight of copper oxide, more preferably at least 99% by weight of copper oxide. In contrast, in the particles of a frit comprising copper oxide, the proportion of copper oxide is much lower.

Particularly preference as constituent (iii) is given to copper(II) oxide CuO, preferably in the form of CuO particles. A “CuO particle” is understood as meaning a particle containing at least 90% by weight of copper(II) oxide, preferably at least 95% by weight of copper(II) oxide, more preferably at least 99% by weight of copper(II) oxide. In contrast, in the particles of a frit comprising copper(II) oxide, the proportion of copper(II) oxide is much lower.

In a preferred composition of the invention, the proportion of particles (iii) of copper oxide is 5% to 20%, in each case based on the weight of constituent (i).

When firing the composition of the invention to produce an enamel functional layer (for details of the process, see below), copper oxide is reduced by iron (metal (a)) from the steel particles (ii) to copper (metal (b)), forming finely branched crystalline structures of copper. However, the iron in the steel particles (ii) is not completely oxidized in this process. In the enamel functional layer, steel particles (ii) remain which are downsized by the consumption of iron due to the redox reaction with copper oxide. The result is an electronically conductive network that passes through the enamel matrix, in which steel particles (ii) embedded in the enamel matrix of the enamel functional layer are connected by crystalline structures formed from the copper produced by reduction of the copper oxide. The crystalline structures formed from copper produced by reduction of copper oxide that connect the steel particles (ii) are typically dendritic and/or network-like in form. Iron oxide formed in the reduction of copper oxide is dissolved in the enamel matrix. The term “iron oxide” here encompasses the individual oxides of iron as well as mixtures thereof.

In a composition of the invention, the proportion of particles (ii) is preferably 10% to 100%, more preferably 15% to 90%, more preferably 20% to 80%, particularly preferably 30% to 70%, in each case based on the weight of constituent (i).

Preferably, the proportion of particles (ii) is greater than 7% based on the total weight of the composition of the invention; more preferably, the proportion of particles (ii) is 10% or more based on the total weight of the composition of the invention.

In a preferred composition of the invention, the proportion of particles (ii) of stainless steel is 10% to 100%, more preferably 15% to 90%, more preferably 20% to 80%, particularly preferably 30% to 70%, in each case based on the weight of constituent (i).

Preferably, the particles (ii) have a d₅₀ value of from 5 μm to 200 μm, more preferably from 50 μm to 200 μm, particularly preferably from 80 μm to 200 μm, in each case determined by laser particle size analysis.

Constituent (iii) is preferably in the form of particles having a d₅₀ value of 1 μm to 5 μm, in each case determined by laser particle size analysis.

Particularly preferably, the particles (ii) are particles of stainless steel having a d₅₀ value of from 5 μm to 200 μm, more preferably from 50 μm to 200 μm, particularly preferably from 80 μm to 200 μm, in each case determined by laser particle size analysis.

Constituent (iii) is particularly preferably in the form of particles of copper oxide, in particular CuO, having a d₅₀ value of 1 μm to 5 μm, in each case determined by laser particle size analysis.

The redox reaction between metal (a), for example iron, and the oxide of metal (b), for example copper oxide, that occurs when the composition of the invention is fired, begins at the surfaces of the particles (ii), at which the metal (a), for example iron, is in contact with the fused frit in which the oxide of metal (b), for example copper oxide, is dissolved (for further details, refer to the description of the process of the invention hereinbelow). The kinetics of the redox reaction between metal (a), for example iron, and the oxide of metal (b), for example copper oxide, that occurs when the composition of the invention is fired, are very strongly dependent on the grain size of the particles (ii). The smaller the particles (ii), the larger the particle surface area relative to the particle weight, and the more rapidly the metal (a), for example iron, is oxidized, and the greater the amount formed of oxide(s) of metal (a), for example iron oxide, relative to the original amount of metal (a), for example iron. If the amount of oxide(s) of metal (a), for example of iron, is too high, the saturation concentration thereof in the melt resulting from firing of the composition of the invention could be exceeded and slagging could develop in the enamel, i.e. a homogeneous enamel matrix would not be formed. In addition, complete oxidation of metal (a), for example iron, must be avoided, in order that unoxidized residues of the particles (ii), for example particles of stainless steel, are available for formation of the electronically conductive network described above. It is therefore preferable that the particles (ii), in particular particles of stainless steel, have a d₅₀ value of at least 5 μm, preferably a d₅₀ value of at least 50 μm, more preferably a d₅₀ value of at least 80 μm, in each case determined by laser particle size analysis.

The described relationship between the size of the particles (ii) and the rate of oxidation means that the smaller the particles (ii) comprising the metal (a), for example iron, the greater the input of oxide(s) of metal (a), for example oxide(s) of iron, into the enamel melt and the more quickly the saturation concentration of the oxide of metal (a) in the enamel melt is reached. The smaller the particles (ii), the lower the chosen concentration of the particles (ii) relative to the frit (i) needs to be in order to avoid supersaturation of the enamel melt with oxide(s) of metal (a), for example oxide(s) of iron. On the other hand, since a sufficiently high concentration of particles (ii), for example particles of stainless steel, is desired for the achievement of high electronic conductivities, it is advantageous when the particles (ii), especially particles of stainless steel, are not too small. Therefore, particles (ii), especially particles of stainless steel, having a d₅₀ value of at least 5 μm, preferably a d₅₀ value of at least 50 μm, more preferably a d₅₀ value of at least 80 μm, in each case determined by laser particle size analysis are preferred.

When particles (ii) of stainless steel having a d₅₀ value of 5 μm are used, the concentration thereof in the composition of the invention should be less than 35%, preferably less than 30%, in each case based on the weight of constituent (i). When particles (ii) of stainless steel having a d₅₀ value of 80 μm are used, the concentration thereof in the composition of the invention may be up to 100%, based on the weight of constituent (i).

The upper limit of the size of the particles (ii), for example particles of stainless steel, is determined by the layer thickness of the enamel functional layer to be produced from the composition of the invention. The upper limit of the particle size is described by the d₁₀₀ value of the particle size distribution: 100% of all particles are smaller than or equal in size to the d₁₀₀ value. The ratio between the d₁₀₀ value of the particles (ii) and the layer thickness of the enamel functional layer to be produced from the composition of the invention is normally less than 1, preferably 0.8 or less, and is at least 0.05. Preferably, the ratio between the d₁₀₀ value of the particles (ii) and the layer thickness of the enamel functional layer to be produced from the composition of the invention is in the range from 0.5 to 0.8.

Preference is given to particles (ii) having an approximate spherical shape, since their low surface area to volume ratio means they show a low tendency to oxidation. However, other particle shapes such as chips or flakes are not excluded. Particles produced by water-jet atomization, which typically have an irregular shape, may also be used.

If the oxide of metal (b), for example copper oxide, is used in the form of particles (as defined above), these should have a d₅₀ value of 5 μm or less in order that the oxide of metal (b) dissolves as rapidly and completely as possible in the melt formed when the frit is fused during firing of the composition.

Preferably, the composition of the invention contains less than 1% by weight of precious metals based on the sum total of the weights of constituent (i) and of the precious metals present, more preferably less than 0.5% by weight of precious metals, based on the sum total of the weights of constituent (i) and of the precious metals present, and particularly preferably less than 0.1% by weight of precious metals based on the sum total of the weights of constituent (i) and of the precious metals present. Particularly preferably, the composition of the invention does not contain any precious metals. Precious metals are metals are selected from the group consisting of gold, silver, mercury, rhenium, ruthenium, rhodium, palladium, osmium, iridium, and platinum.

A composition of the invention, especially in its preferred embodiments defined above, is suitable for producing an electronically conductive enamel layer. Accordingly, the use of a composition of the invention for producing an electronically conductive enamel layer forms an essential aspect of the present invention. “Electronically conductive” in the context of the present invention means that the charge transport is effected by electrons. Preferably, the electronic conductivity at a voltage of 100 V of an electronically conductive enamel layer produced using a composition of the invention is 10⁻¹⁰ S/cm or more, preferably 10⁻⁹ S/cm or more, more preferably 10⁻⁸ S/cm or more. A measurement method is described in the examples.

The composition of the invention is particularly suitable for producing an electronically conductive corrosion protection layer on the spray electrode and precipitation electrode of an electrostatic precipitator (electrostatic filter). The requirements for the puncture resistance of the enamel layer are particularly high here because, in the medium coming into contact with the enamel layer, high concentrations of charge carriers are generated by the active voltage source, i.e. there is a constant, very high external electrical voltage potential acting on the surface of the enamel layer from its exterior.

The compositions that are according to the invention particularly preferred are suitable for coating the precipitation electrode of an electrostatic precipitator, since their high electronic conductivity means that the formation of secondary charge carriers and the back-spraying thereof to the spray electrode is avoided.

An enamel functional layer formed from a composition of the invention is usually covered with an enamel cover layer, where the concentration of particles (ii) comprising at least one metal (a) is lower in the enamel cover layer than in the enamel functional layer. Preferably, the concentration of particles (ii) comprising at least one metal (a) in the enamel cover layer is less than 2% by volume. Particularly preferably, the enamel cover layer does not contain any metallic constituents having a standard electrode potential more negative than the standard electrode potential of metal (b).

The enamel cover layer largely prevents particles (ii) comprising a metal (a) from being exposed at the surface of the enamel coating and thus from being exposed to corrosive influences. In addition, by a low proportion of particles (ii) comprising at least one metal (a) in the enamel cover layer, properties are achieved in the surface of the enamel coating comprising an enamel functional layer formed from a composition of the invention that largely correspond to the properties of a conventional enamel coating, especially with regard to hydrolytic and chemical resistance and impact resistance. This is an advantage over the enamel coatings disclosed in WO 2013/083680 A2.

Therefore, a composition of the invention is preferably used in combination with a composition for producing an enamel cover layer. The composition for producing the enamel cover layer comprises a frit suitable for forming a cover enamel. Constituent (ii) of the composition of the invention is not present in the composition for producing the enamel cover layer. The composition for producing the enamel cover layer comprises the same oxide of a metal (b) or a precursor for forming an oxide of the same metal (b) as the composition of the invention. This ensures that the finely branched crystalline structures formed from the metal (b) produced by reduction of the oxide of metal (b) grow up to the surface of the enamel cover layer.

The invention thus also provides a kit comprising
(1) a composition of the invention as described above
(2) and a composition for producing an enamel cover layer, where the composition (2) comprises
   a frit for forming an enamel matrix,
   an oxide of a metal (b) or a precursor for forming an oxide of a metal (b), where the oxide of metal (b) or the precursor for forming an oxide of a metal (b) is identical in compositions (1) and (2),
   where composition (2) does not contain constituent (ii) as defined above.

The composition (2) for producing an enamel cover layer does not contain constituent (ii) of a composition of the invention, i.e. composition (2) does not contain particles of a metal (a). Preferably, the composition (2) does not contain any metallic constituents having a standard electrode potential more negative than the standard electrode potential of metal (b).

The total concentration of oxide of metal (b) in composition (2) corresponds to at most the saturation concentration of this oxide in the melt formed when composition (2) is fired to produce an enamel cover layer (for details of the process, see below). With regard to preferred oxides of metals (b) or precursors thereof, the same considerations apply as explained above for the composition of the invention.

Frits suitable for producing a cover enamel are known to those skilled in the art, see the statements above.

Particular preference is given to a kit comprising
(1) a composition of the invention as described above, where
   the particles (ii) comprise stainless steel,
   constituent (iii) is an oxide of copper, preferably CuO, and is in the form of particles and
(2) a composition for producing an enamel cover layer, where the composition (2) comprises
   a frit suitable for forming a cover enamel,
   a particulate copper oxide identical to constituent (iii) of composition (1), preferably CuO, where composition (2) does not contain any metallic constituents.

A kit according to the invention, especially in the preferred embodiments defined above, is suitable for producing an article comprising an enamel functional layer and an enamel cover layer arranged on the surface of the enamel functional layer facing away from the base body. In the preferred kit of the invention defined above, the composition (2) for producing an enamel cover layer comprises the same particulate copper oxide as the composition of the invention for producing the functional layer.

This ensures that the finely branched crystalline structures formed from the copper produced by reduction of the oxide of metal (b) grow up to the surface of the enamel cover layer.

A further aspect of the present invention is a process for producing an enamel coating on a base body. The process of the invention comprises the following steps:
(S1) providing a base body,
(S2) forming two or more layers on the surface of the base body, each layer being formed by applying a composition comprising a frit for forming an enamel matrix, where at least one of the applied compositions is a composition of the invention as defined above and the composition applied last is a composition (2) for producing an enamel cover layer as defined above,
(S3) firing the formed layers, the firing taking place either after applying a single composition or after applying more than one composition or all compositions, with a firing always carried out after applying the last composition.

The process of the invention is used for producing an article comprising a base body, an enamel functional layer that is electronically conductive, and an enamel cover layer.

The nature and quality of the base body to be provided in step (S1) of the process of the invention is determined by the article to be produced. The base body in its entirety, or at least the surface of the base body on which an enamel functional layer is to be produced, typically consists of metallic materials, for example cast iron, steel or aluminum.

In step (S2) of the process of the invention, two or more layers are formed on the surface of the base body, each layer being formed by applying a composition comprising a frit for forming an enamel matrix. In this case, at least one of the applied compositions is a composition of the invention as defined above, preferably one of the preferred compositions of the invention described above, and the composition applied last is a composition (2) for producing an enamel cover layer as defined above, preferably one of the preferred compositions described above (2). The layer formed from the composition of the invention represents the precursor of the enamel functional layer to be produced. The layer formed last represents the precursor of an enamel cover layer.

Step (S2) comprises a number of substeps corresponding to the number of layers to be formed. At least one of the compositions applied is here a composition of the invention as described above. It is also possible for a plurality of layers to be formed by applying a composition of the invention.

In some cases, just one layer is formed by applying a composition of the invention, and an enamel cover layer is formed by applying a composition (2) as defined above for producing an enamel cover layer.

The composition for the layer to be formed directly on the surface of the base body advantageously comprises a frit comprising one or more bonding oxides. This layer represents the precursor of an enamel base layer. When the composition of the invention is applied directly onto the surface of the base body, this composition of the invention advantageously comprises a frit comprising one or more bonding oxides.

The composition for producing the enamel cover layer comprises the same oxide of a metal (b) or a precursor for forming an oxide of the same metal (b) as the composition of the invention. This ensures that growth of the finely branched crystalline structures formed from the metal (b) produced by reduction of the oxide of metal (b) extends as far as the surface of the enamel cover layer.

When a composition for producing an enamel base layer is applied to the surface of the base body before applying the composition of the invention, then this composition preferably comprises the same oxide of a metal (b), or a precursor for forming an oxide of the same metal (b), for example copper oxide, as the composition of the invention. This promotes the growth of the finely branched crystalline structures formed from the metal (b) produced by reduction of the oxide of metal (b) up to the surface of the base body. Reduction of the oxide of metal (b) present in the composition for producing the enamel base layer by iron, or by other metals from the base body having a standard electrode potential more negative than metal (b), results in the formation of additional metal (b).

Suitable techniques for applying the compositions are known to those skilled in the art, for example spraying, sputtering, dipping, and flooding.

In step (S3) of the process of the invention, the layers formed on the surface of the base body are fired, with each applied composition resulting in a layer comprising an enamel matrix. This firing can in each case take place after applying a single composition or after applying more than one or all compositions. In all cases, the application of the last composition is followed by firing.

When firing the layer formed from the composition of the invention, the frit (i) is fused and the oxide of metal (b) is reduced by metal (a) to metal (b), forming an enamel functional layer comprising
(i) an enamel matrix comprising an oxide formed by oxidation of metal (a), and, embedded in the enamel matrix,
(ii) particles comprising at least one metal (a),
(iii) finely branched crystalline structures, formed through reduction of an oxide, of a metal (b) having a standard electrode potential more positive than the standard electrode potential of metal (a).

During fusing of the frit (i), the oxide of metal (b), for example copper oxide, dissolves in the glass melt that forms. Once the frit (i) has fused completely, the oxide of metal (b), for example copper oxide, will be dissolved in the glass melt. The particles (ii), for example steel particles, are thus in contact with a melt that, in addition to the constituents of the frit (i), comprises the oxide of metal (b), for example copper oxide. At the interfaces between the melt and the particles (ii), the oxide of metal (b), for example copper oxide, will then be reduced to crystals of metal (b), for example copper crystals, and the oxidation products of metal (a) formed in this process (in the case of stainless steel, mostly iron oxide, and also oxides of molybdenum, nickel, and chromium, where present) dissolve in the glass melt and become a constituent of the enamel matrix formed from the cooling glass melt. In the immediate vicinity of the particles (ii), for example particles of stainless steel, finely branched crystalline structures of newly formed metal (b), for example copper crystals, then form, which grow into the surrounding glass melt with increasing firing time.

The enamel matrix of the enamel functional layer is passed through by an electronically conductive network generated in situ during firing, in which particles (ii) of metal (a) embedded in the enamel matrix of the enamel functional layer are connected by crystalline structures (iii) of metal (b) produced by reduction of its oxide. The crystalline structures formed from metal (b) produced by reduction of its oxide that connect the particles (ii) of metal (a) are typically dendritic and/or network-like in form.

Since the composition for producing the enamel cover layer comprises the same oxide of a metal (b), for example copper oxide, or a precursor for forming an oxide of the same metal (b) as the composition of the invention, the growth of the finely branched crystalline structures composed of newly formed metal (b), for example copper, extends up to the surface of the enamel cover layer.

The electronically conductive contact with the surface of the base body is produced by the oxide of metal (b), for example copper oxide, present in the composition for producing an enamel base layer being reduced by iron, or by other metals from the base body having a standard electrode potential more negative than metal (b), with the result that finely branched crystalline structures of metal (b) form in the enamel base layer too. In the case of a very thin enamel base layer, it is also possible to use for its production a composition that does not contain any oxide of a metal (b). When the enamel functional layer is fired, the enamel base layer is then supplied by the oxide of metal (b), for example copper oxide, which diffuses in from the composition of the invention.

An electronic conductivity is thus achieved parallel to the layer thickness of the enamel coating, from the surface of the base body to the surface of the enamel cover layer.

In a variant of the process of the invention, all compositions are first applied, and the layers thus formed then fired together. In another variant, the application of each individual composition is first followed by firing of the resulting layer before the next composition is applied and the next layer fired, until application of the last composition and subsequent firing of the last layer. In this case, step (S3) comprises a number of substeps corresponding to the number of layers to be fired, with each substep of step (S3) following on from the corresponding substep of step (S2).

It will be obvious to those skilled in the art that the process of the invention permits a diversity of further variations with regard to the sequence of the different substeps of the above-defined steps (S2) and (S3). For example, a plurality of superimposed layers may first be formed by successive application of compositions, each comprising a frit for forming an enamel matrix, which are then fired together before one or more further layers each comprising a frit for forming an enamel matrix are formed and fired through application of one or more further compositions.

Those skilled in the art are familiar with suitable techniques and devices for firing the layers.

The temperature at which the firing of individual layers or a plurality thereof takes place depends on the composition of the layer, in particular on the frit present therein, and on the nature of the base body and the article to be produced. The firing temperature of the functional layer is typically in the range from >600° C. to 980° C., preferably 620° C. to 950° C., more preferably 650° C. to 950° C. Those skilled in the art are able to select the appropriate firing temperature based on their own specialist knowledge. The same applies to the firing time. The firing time is typically in the range from 0.5 to 60 minutes.

Given below are some particularly preferred variants of the process of the invention:
In a preferred variant, the process of the invention comprises the steps of
(S1) providing a base body,
(S2a) forming a first layer by applying a composition of the invention as defined above that comprises a frit comprising one or more bonding oxides typical of a base-coat enamel,
(S2b) forming a second layer by applying a composition (2) as defined above for the production of an enamel cover layer,
(S3) firing the layers formed in steps (S2a) and (S2b).

In a preferred variant, the process of the invention comprises the steps of
(S1) providing a base body,
(S2a) forming a first layer by applying a composition of the invention as defined above that comprises a frit comprising one or more bonding oxides typical of a base-coat enamel,
(S3a) firing the layer formed in step (S2a),
(S2b) forming a second layer by applying a composition (2) as defined above for the production of an enamel cover layer,
(S3b) firing the layer formed in step (S2b).

In another preferred variant, the process of the invention comprises the steps of
(S1) providing a base body,
(S2a) forming a first layer by applying a composition that comprises a frit comprising one or more bonding oxides typical of a base enamel, where this composition does not contain the above-defined constituent (ii) of the compositions of the invention,
(S2b) forming a second layer by applying a composition of the invention as defined above,
(S2c) forming a third layer by applying a composition (2) as defined above for the production of an enamel cover layer,
(S3) firing the layers formed in steps (S2a), (S2b), and (S2c).

In a further preferred variant, the process of the invention comprises the steps of
(S1) providing a base body,
(S2a) forming a first layer by applying a composition that comprises a frit comprising one or more bonding oxides typical of a base enamel, where this composition does not contain the above-defined constituent (ii) of the compositions of the invention,
(S3a) firing the layer formed in step (S2a),
(S2b) forming a second layer by applying a composition of the invention as defined above,
(S3b) firing the layer formed in step (S2b),
(S2c) forming a third layer by applying a composition (2) as defined above for the production of an enamel cover layer,
(S3c) firing the layer formed in step (S2c).

In a next preferred variant, the process of the invention comprises the steps of
(S1) providing a base body,
(S2a) forming a first layer by applying a composition that comprises a frit comprising one or more bonding oxides typical of a base enamel, where this composition does not contain the above-defined constituent (ii) of the compositions of the invention,
(S2b) forming a second layer by applying a composition of the invention as defined above,
(S3a) firing the layers formed in steps (S2a) and (S2b),
(S2c) forming a third layer by applying a composition (2) as defined above for the production of an enamel cover layer,
(S3b) firing the layer formed in step (S2c).

In a next preferred variant, the process of the invention comprises the steps of
(S1) providing a base body,
(S2a) forming a first layer by applying a composition that comprises a frit comprising one or more bonding oxides typical of a base enamel, where this composition does not contain the above-defined constituent (ii) of the compositions of the invention,
(S3a) firing the layer formed in step (S2a),
(S2b) forming a second layer by applying a composition of the invention as defined above,
(S2c) forming a third layer by applying a composition (2) as defined above for the production of an enamel cover layer,
(S3b) firing the layers formed in steps (S2b) and (S2c).

### BRIEF DESCRIPTION OF THE DRAWINGS

A detailed description of preferred embodiments follows, with reference to the attached drawings, wherein:

FIGS. 1a and 1b illustrate a process according to the invention; and

FIG. 2 illustrates a test setup referred to in the examples.

### DETAILED DESCRIPTION

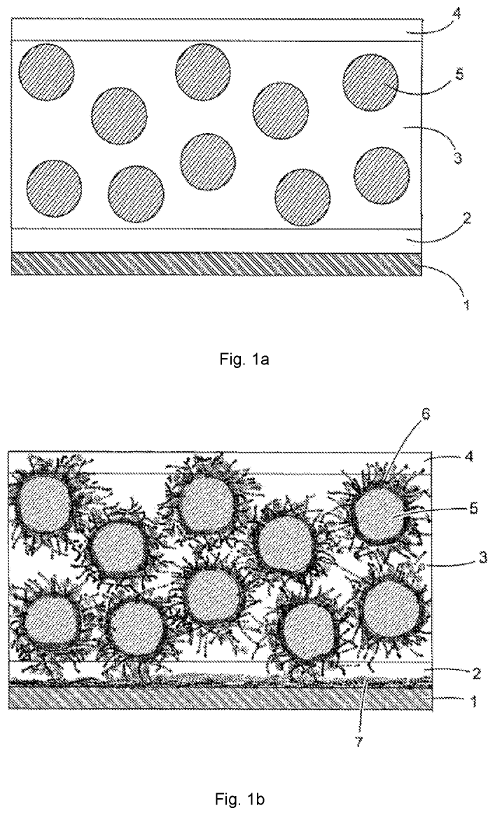

The state before and after firing is illustrated by way of example in FIGS. 1a and 1b for a process in which the following compositions were applied in step 2:
Step (S2a) Applying to the surface of a base body 1 a composition for producing an enamel base layer 2 that does not contain any metallic constituents
Step (S2b) Applying a composition of the invention comprising particles of stainless steel 5 as constituent (ii) and particulate CuO as constituent (iii) for producing an enamel functional layer 3
Step (S2c) Applying a composition for producing an enamel cover layer 4 that comprises the same constituent (iii) (particulate CuO) as the composition of the invention applied in step (S2b) and no metallic constituents

FIG. 1a shows a cross-section through the layers 2, 3, and 4 formed in steps (S2a)-(S2c) on the base body 1 by applying the above compositions before the start of firing. In the layer 3 formed in step (S2b), the particles (ii) of stainless steel 5 present are isolated from one another and there is no electronic contact between the particles (ii) of stainless steel 5 and the surface of the base body 1 or surface of the layer 4 applied in step (S2c).

During firing, finely branched crystalline structures of newly formed copper 6 will have formed in the enamel functional layer 3 starting from the interfaces between the molten frit and the particles (ii) of stainless steel 5, which will have grown into the surrounding glass melt with increasing firing time, bringing the particles (ii) of stainless steel 5 into electronic contact with the surface of the base body 1 and the surface of the enamel cover layer 4 (FIG. 1b). The contact with the surface of the base body 1 is particularly well developed when, for the production of the enamel base layer 2 in step (S2a), a composition is applied that comprises the same constituent (iii) (particulate CuO) as the composition of the invention applied in step (S2b) for the production of the enamel functional layer 3. In that case, additional copper 7 can be formed in the enamel base layer 2 through reduction of the CuO present in the composition for producing the enamel base layer by iron or by other metals from the base body 1 having a standard electrode potential more negative than copper.

The present invention also relates to an article comprising a base body and an enamel functional layer and an enamel cover layer arranged on the surface of the enamel functional layer facing away from the base body. In certain cases, the article of the invention consists of a base body, an enamel functional layer, and an enamel cover layer arranged on the surface of the enamel functional layer facing away from the base body.

The enamel functional layer of the article of the invention comprises
(i) an enamel matrix and, embedded in the enamel matrix,
(ii) particles comprising at least one metal (a),
(iii) crystals, formed through reduction of an oxide, of a metal (b) having a standard electrode potential more positive than the standard electrode potential of metal (a), where the enamel matrix (i) comprises an oxide formed by oxidation of metal (a).

In the enamel functional layer, the particles (ii) are present as discrete particles optically distinguishable from the enamel matrix (i). The proportion of particles (ii) in the enamel functional layer is preferably 2% by volume to 40% by volume based on the volume of the enamel functional layer.

The concentration of particles (ii) comprising at least one metal (a) is lower in the enamel cover layer than in the enamel functional layer. Preferably, the concentration of particles (ii) comprising at least one metal (a) in the enamel cover layer is less than 2% by volume. Preferably, the enamel cover layer does not contain any particles (ii) comprising at least one metal (a). Particularly preferably, the enamel cover layer does not contain any metallic constituents having a standard electrode potential more negative than the standard electrode potential of metal (b).

The enamel functional layer and the enamel cover layer of the article of the invention comprise crystals, formed through reduction of an oxide, of a metal (b) having a standard electrode potential more positive than the standard electrode potential of metal (a). (It follows from the above statements that the metal (b) in the enamel functional layer and in the enamel cover layer is identical, i.e. the enamel functional layer and the enamel cover layer comprise the same metal (b)).

In the enamel functional layer and the enamel cover layer, the metal (b) produced by reduction of an oxide forms finely branched crystalline structures (iii) that connect the particles (ii) embedded in the enamel matrix (i) of the enamel functional layer into an electronically conductive network. The crystalline structures (iii) of metal (b) produced by reduction of an oxide that connect the particles (ii) are typically dendritic and/or network-like in form and extend from the surface of the base body up to the surface of the enamel cover layer. The oxide of metal (a) formed in the reduction of the oxide of metal (b) is dissolved in the enamel matrix (i).

Because the electronic contact between the particles (ii) is produced by finely branched crystalline structures (iii) of metal (b) produced by reduction of its oxide, there is no need for direct contact between the particles (ii) and the production of a comparable electronic conductivity requires a lower concentration of particles (ii) in the functional layer is required than in an electronically conductive enamel layer according to WO 2013083680A2. This is advantageous because the smaller the volume of the embedded discrete solid metal particles (ii), the lesser the effect on the continuity and properties of the enamel matrix (i). On the other hand, the finely branched crystalline structures (iii) of metal (b) produced by reduction of its oxide have a lower influence on the continuity and the properties of the enamel matrix (i), because they pervade the enamel matrix but do not break it up, as occurs with solid discrete particles.

The thickness of the enamel cover layer is not more than 50% of the thickness of the enamel functional layer, preferably 25% of the thickness of the enamel functional layer or less, more preferably 5% of the thickness of the enamel functional layer or less.

In a preferred embodiment, the enamel functional layer of the article of the invention comprises
(i) an enamel matrix comprising iron oxide and, embedded in the enamel matrix,
(ii) particles comprising stainless steel,
(iii) copper crystals formed through reduction of an oxide of copper,
and the enamel cover layer comprises copper crystals formed through reduction of an oxide of copper, where the concentration in the enamel cover layer of particles (ii) comprising stainless steel is lower than in the enamel functional layer.

Preferably, the concentration of particles (ii) comprising stainless steel in the enamel cover layer is less than 2% by volume. Preferably, the enamel cover layer does not contain any particles (ii) comprising at least one metal (a) having a standard electrode potential more negative than the standard electrode potential of copper. Particularly preferably, the enamel cover layer does not contain any metallic constituents having a standard electrode potential more negative than the standard electrode potential of copper.

Preferably, the enamel functional layer has a thickness of 100 μm to 500 μm, more preferably 200 μm to 30 μm, and the enamel cover layer has a thickness in the range from 1 μm to 50 μm, more preferably 10 μm to 50 μm, in each case determined by magneto-inductive measurement.

In the enamel functional layer and enamel cover layer of the article of the invention, copper forms crystalline structures (iii) that connect the particles (ii) embedded in the enamel matrix (i) of the enamel functional layer into an electronically conductive network. The crystalline structures (iii) formed from the copper produced by reduction of copper oxide that connect the particles (ii) are typically dendritic and/or network-like in form. Iron oxides formed in the reduction of copper oxide are dissolved in the enamel matrix (i).

The steel particles (ii) are present as discrete particles optically distinguishable from the enamel matrix (i). The proportion of steel particles (ii) in the enamel functional layer is preferably 2% by volume to 40% by volume based on the volume of the enamel functional layer.

The proportion of metallic copper (iii) in the enamel functional layer is preferably 3% to 20% based on the weight of the enamel functional layer.

A preferred article of the invention additionally comprises an enamel base layer arranged between the surface of the base body and the enamel functional layer, preferably having a thickness in the range from 1 μm to 50 μm, more preferably 10 μm to 50 μm, where the concentration of particles (ii) comprising at least one metal (a) is lower in the enamel base layer than in the enamel functional layer. Preferably, the enamel base layer does not contain any particles (ii) comprising at least one metal (a). Particularly preferably, the enamel cover layer does not contain any metallic constituents having a standard electrode potential more negative than the standard electrode potential of metal (b).

The thickness of the enamel base layer is not more than 50% of the thickness of the enamel functional layer, preferably 25% of the thickness of the enamel functional layer or less, more preferably 5% of the thickness of the enamel functional layer or less.

The enamel base layer, enamel functional layer, and enamel cover layer of the article of the invention comprise crystals, formed through reduction of an oxide, of a metal (b) having a standard electrode potential more positive than the standard electrode potential of metal (a). In the enamel base layer, enamel functional layer, and enamel cover layer, the metal (b) produced by reduction of an oxide forms finely branched crystalline structures that connect the particles (ii) embedded in the enamel matrix (i) of the enamel functional layer into an electronically conductive network. The crystalline structures formed from the metal (b) produced by reduction of an oxide that connect the particles (ii) are typically dendritic and/or network-like in form and extend from the surface of the base body as far as the surface of the enamel cover layer. The oxide of metal (a) formed in the reduction of the oxide of metal (b) is dissolved in the enamel matrix.

A particularly preferred article of the invention comprises
an enamel base layer arranged between the surface of the base body and the enamel functional layer, preferably having a thickness in the range from 1 μm to 50 μm, more preferably 10 μm to 50 μm
   and
an enamel cover layer arranged on the surface of the enamel functional layer facing away from the base body, preferably having a thickness in the range from 1 μm to 50 μm, more preferably 10 μm to 50 μm,
   where the concentration of particles (ii) comprising at least one metal (a) is lower in the enamel base layer and in the enamel cover layer than in the enamel functional layer. Preferably, the concentration of particles (ii) comprising at least one metal (a) in the enamel cover layer and in the enamel base layer is less than 2% by volume. Preferably, the enamel base layer and the enamel cover layer do not contain any particles (ii) comprising at least one metal (a). Particularly preferably, the enamel base layer and the enamel cover layer do not contain any metallic constituents having a standard electrode potential more negative than the standard electrode potential of metal (b).

The article having an enamel functional layer article is preferably selected from the group consisting of
dry and wet electrostatic precipitators, especially for scrubbing corrosive exhaust gases,
plant and reactors, pipelines, and fittings,
containers and baths, especially for storing corrosive media.

Another aspect of the present invention is the use of an enamel functional layer as defined above as an antistatic coating or as an electronically conductive corrosion protection coating.

Preferably, the enamel functional layer is able to perform both functions.

The use as an antistatic layer relates to areas of application where enamel layers are exposed to high electrical voltages caused by triboelectric charging that can lead to voltage-induced puncture, for example silos for bulk materials, tanks for electrically insulating liquids, and chemical reactors.

The use as an electronically conductive corrosion protection layer relates to areas of application where a high resistance to chemical corrosion is needed and at the same time an adequate electronic conductivity is an absolutely necessity, for example spray electrodes and precipitation electrodes for separating dust from the exhaust gas stream of a combustion plant, for example a biomass-operated combustion plant.

The present invention will be elucidated in more detail hereinbelow on the basis of exemplary embodiments.

### Example 1: Production of Enamel Coatings

Articles having an enamel functional layer as defined above were produced by a process having the following steps:
(S1) providing a base body made of hot-rolled steel, as is commonly used in container construction
(S2a) forming a first layer by applying a noninventive composition comprising
   a frit, where this frit comprises bonding oxides typical of a base-coat enamel,
   and no metal particles (constituent (ii) of an inventive composition as described above) (S2b) forming a second layer by applying an inventive composition comprising
   (i) a frit,
   (ii) particles (ii) of 3161 stainless steel in an amount of 50% based on the weight of the frit (i); for details of particle size, see Table 1
   (iii) CuO particles in an amount of 10% based on the weight of the frit (i)
(S3a) firing the layers formed in steps (S2a) and (S2b) at a temperature in the range from 800° C. to 880° C. for a period of 6 min
(S2c) in some cases forming a third layer by applying a noninventive composition comprising
   a frit suitable for forming a cover enamel,
   no metal particles (constituent (ii) of an inventive composition as described above),
   CuO particles in an amount of 10% based on the weight of the frit
(S3b) firing the layer formed in step (S2c) in layers at a temperature in the range from 800° C. to 880° C. for a period of 6 min.

Thus, articles were obtained comprising an enamel base layer arranged between the surface of the base body and the enamel functional layer, and in some cases an enamel cover layer arranged on the surface of the enamel functional layer facing away from the base body.

The thicknesses of the coating obtained (totality of enamel base layer, enamel functional layer and—if present—enamel cover layer) were determined magneto-inductively using a paint coating thickness gauge. The values are given in Table 1.

### Example 2: Determination of the Specific Electrical Conductivity

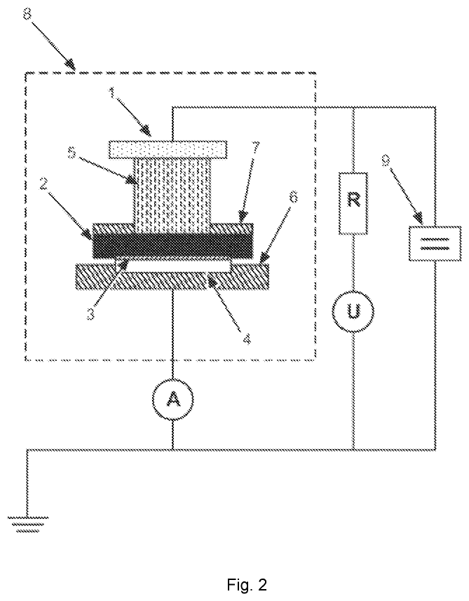

Current-voltage curves were recorded using the test setup shown in FIG. 2, which is constructed in accordance with the standard VDE 0303, Part 30.

The surface of the copper HV electrode 1 lies directly on the surface of the semiconductor body 5 (thickness 1 mm), which in turn rests on the surface of the test specimen 2 under investigation. The test specimen 2 under investigation is electrically connected to the copper HV electrode 4 via the contact 3. The HV electrode 4 has an insulator 6 at the sides and back. Through an insulator 7 that rests on the surface of the test specimen 2 and in which there is a blanked out region having 25 cm² in area, a defined surface of the test specimen 2 is exposed. This test assembly is surrounded by a shield 8. The power supply was provided by a DC generator 9. The current is measured with the ammeter A.

The ambient conditions (temperature and humidity) were kept constant during the tests in order to exclude measurement errors caused by fluctuating electrical air flow resistance.

Present in the test set up shown in FIG. 2, between the copper electrodes 1 and 4, is an assembly of electrical resistors (semiconductor body 5 and test specimen 2) connected in series, the total resistance of which is obtained as the sum total of the individual resistances. Since the resistances of the copper electrodes are negligible and the resistance of the semiconductor body 5 is defined by its material and dimensions, the resistance of the test specimen 2 is obtained by subtracting the resistance of the semiconductor body 5 from the total resistance. The specific conductivities calculated therefrom are shown in Table 1.

TABLE 1

| | Particle | | | Specific |
|---|---|---|---|---|
| | diameter of the | | Layer | electrical |
| Sample | particles (ii)/ | Step | thickness/ | conductivity/ |
| No. | [μm] | (S2c) | [mm] | [S/cm] at 100 V |
| 1 | 80 to 90 | − | 0.213 | 8.77 * 10⁻⁰⁹ |
| 2 | 80 to 90 | − | 0.202 | 1.23 * 10⁻⁰⁸ |
| 3 | 80 to 90 | − | 0.209 | 1.35 * 10⁻⁰⁸ |
| 4 | 80 to 90 | + | 0.222 | 1.64 * 10⁻⁰⁸ |
| 5 | 80 to 90 | + | 0.202 | 6.82 * 10⁻⁰⁹ |
| 6 | 80 to 90 | + | 0.220 | 2.45 * 10⁻⁰⁸ |
| 7 | 100 to 125 | − | 0.213 | 5.57 * 10⁻⁰⁸ |
| 8 | 100 to 125 | − | 0.228 | 2.59 * 10⁻⁰⁸ |
| 9 | 100 to 125 | − | 0.225 | 2.16 * 10⁻⁰⁸ |
| 10 | 100 to 125 | + | 0.249 | 8.57 * 10⁻⁰⁹ |
| 11 | 100 to 125 | + | 0.252 | 2.42 * 10⁻⁰⁸ |
| 12 | 100 to 125 | + | 0.240 | 2.34 * 10⁻⁰⁸ |

The comparison of samples 1-3 with samples 4-6 and of samples 7-9 with samples 10-12 shows: an additional enamel cover layer produced from a composition comprising copper oxide and no metal particles causes only a small decrease in conductivity compared to the samples having an enamel base layer and enamel functional layer of in each case identical composition and no cover layer. This shows that the reduction of the copper oxide by iron from the steel particles extends into the enamel cover layer and up to the surface of the base body, even though the composition for the enamel base layer did not contain CuO.

### Example 3: Hydrolytic Resistance

The test of hydrolytic resistance to steam and to boiling water was carried out in accordance with DIN EN IS028706-2:2017, Part 2.

Articles having an enamel functional layer as defined above were produced as described in example 1, except for the following differences:
The composition for the enamel base layer contained CuO particles in an amount of 10% based on the weight of the frit (i).
The enamel functional layer employed only particles (ii) of 3161 stainless steel having a particle diameter of 80 μm to 90 μm.
The production of the enamel cover layer employed different compositions (samples 3 and 4, see Table 2).

In addition, reference samples were produced by
(S1) providing a base body made of hot-rolled steel, as is commonly used in container construction
(S2a) forming a first layer by applying a noninventive composition comprising a frit, where this frit comprises bonding oxides typical of a base-coat enamel,
(S2c) forming a second layer by applying a noninventive composition comprising a frit suitable for forming a cover enamel,
(S3) firing the layers formed in steps (S2a) and (S2c) at a temperature in the range from 800° C. to 880° C. for a period of 6 min.

The compositions applied in steps (2a) and (2c) did not contain the above-defined constituents (ii) and (iii) of the inventive compositions. The layer thickness of the enamel coating of the reference sample determined magneto-inductively using a coating thickness gauge was 200 μm.

The test results are given in Table 2.

TABLE 2

| | | | Total loss in | Conductivity of | |
|---|---|---|---|---|---|
| | | | weight per unit | test solution | Conductivity of |
| Sample | Structure of the | Tested | area | before test | eluate after test |
| No. | enamel coating | phase | ΔρA in g/m² | [μS/cm] | [μS/cm] |
| 1 | Reference | Vapor | 0.88 | | |
| | | state | | | |
| | | Liquid | 0.97 | 2 | 43 |
| 2 | Enamel base layer + | Vapor | 3.78 | | |
| | enamel functional layer | state | | | |
| | | Liquid | 1.49 | 1 | 182 |
| 3 | Enamel base layer + | Vapor | 1.53 | | |
| | enamel functional layer + | state | | | |
| | enamel cover layer | Liquid | 0.88 | 2 | 59 |
| 4 | Enamel base layer + | Vapor | 1.09 | | |
| | enamel functional layer + | state | | | |
| | enamel cover layer | Liquid | 0.40 | 2 | 54 |
| | with addition of | | | | |
| | quartz powder | | | | |

The comparison of sample 3 with sample 2 shows that the hydrolytic resistance to steam and hot water is markedly increased by the enamel cover layer and approaches the properties of a conventional enamel coating (sample 1) without the enamel functional layer produced from a composition of the invention. Further improvements can be achieved through suitable additives such as quartz powder in the composition for the enamel cover layer.

1. A kit comprising
(1) a composition for producing an enamel functional layer, comprising
(i) a frit for forming an enamel matrix,
(ii) particles comprising at least one metal (a), where the particles (ii) have a d₅₀ value of 5 μm to 200 μm, determined by laser particle size analysis,
(iii) an oxide of a metal (b) or a precursor for forming an oxide of a metal (b),
where constituent (iii) is a constituent of the frit (i),
or is in the form of particles having a d₅₀ value of 1 μm to 5 μm, determined by laser particle size analysis,
where the standard electrode potential of metal (b) is more positive than the standard electrode potential of metal (a),
where the proportion of particles (ii) is 10% to 100% based on the weight of the frit (i)
(2) and a composition for producing an enamel cover layer, where the composition (2) comprises
a frit for forming an enamel matrix,
an oxide of a metal (b) or a precursor for forming an oxide of a metal (b), where the oxide of metal (b) or the precursor for forming an oxide of a metal (b) is identical to constituent (iii) of composition (1),
where composition (2) does not contain constituent (ii).

2. The kit as claimed in claim 1, wherein, in the composition (1) for producing an enamel functional layer,
the particles (ii) comprise stainless steel,
constituent (iii) is an oxide of copper or metallic copper as a precursor for forming an oxide of copper.

3. A process for producing an enamel coating on a base body, comprising the steps of
(S1) providing a base body,
(S2) forming two or more layers on the surface of the base body, each layer being formed by applying a composition comprising a frit, where at least one of the applied compositions is a composition for producing an enamel functional layer as claimed in claim 1 and the composition applied last is a composition (2) for producing an enamel cover layer as defined in claim 1,
(S3) firing the formed layers, the firing taking place either after applying a single composition or after applying more than one layer or all layers, with a firing always carried out after applying the last composition.

4. An article comprising
a base body,
an enamel functional layer comprising
(i) an enamel matrix and, embedded in the enamel matrix,
(ii) particles comprising at least one metal (a),
(iii) crystals, formed through reduction of an oxide, of a metal (b) having a standard electrode potential more positive than the standard electrode potential of metal (a),
where the enamel matrix (i) comprises an oxide formed by oxidation of metal (a),
an enamel cover layer arranged on the surface of the enamel functional layer facing away from the base body, where the concentration of particles (ii) comprising at least one metal (a) is lower in the enamel cover layer than in the enamel functional layer, and the enamel cover layer comprises crystals, formed through reduction of an oxide, of a metal (b) having a standard electrode potential more positive than the standard electrode potential of metal (a),
optionally an enamel base layer arranged between the surface of the base body and the enamel functional layer, where the concentration of particles (ii) comprising at least one metal (a) is lower in the enamel base layer than in the enamel functional layer, and the enamel base layer comprises crystals, formed through reduction of an oxide, of a metal (b) having a standard electrode potential more positive than the standard electrode potential of metal (a).

5. The article as claimed in claim 4, wherein the enamel functional layer comprises
(i) an enamel matrix comprising iron oxide and, embedded in the enamel matrix,
(ii) particles comprising stainless steel,
(iii) copper crystals formed through reduction of an oxide of copper
and the enamel cover layer comprises copper crystals formed through reduction of an oxide of the copper.

6. The article as claimed in claim 4, wherein
the enamel functional layer has a thickness of 100 μm to 500 μm,
the enamel cover layer has a thickness in the range from 1 μm to 50 μm,
the enamel base layer has a thickness in the range from 1 μm to 50 μm.

7-10. (canceled)
